(19) United States
(12) Patent Application Publication
(10) Pub. No.: US 2016/0069250 A1
(43) Pub. Date: Mar. 10, 2016

(54) CONTROL VALVE FOR PRE-COMBUSTION CHAMBER ASSEMBLY

(71) Applicant: Caterpillar Inc., Peoria, IL (US)

(72) Inventor: Andrew J. Loetz, West Lafayette, IN (US)

(73) Assignee: Caterpillar Inc., Peoria, IL (US)

(21) Appl. No.: 14/940,177

(22) Filed: Nov. 13, 2015

(51) Int. Cl. F02B 19/02

(52) U.S. Cl. CPC F02B 19/02

(57) ABSTRACT

An engine with a cylinder, a cylinder head, a main combustion chamber, a pre-combustion chamber assembly, and a control valve is provided. The main combustion chamber is disposed in the cylinder. The pre-combustion chamber assembly is disposed in the cylinder head. The pre-combustion chamber assembly includes a pre-chamber portion in fluid communication with the main combustion chamber. The pre-combustion chamber assembly includes a tip portion, which includes at least one orifice to allow fluid communication between the main combustion chamber and the pre-chamber portion. The control valve is accommodated in the pre-chamber portion and is mechanically switchable between a closed position and an open position. The control valve is adapted to be switched to the closed position when fluid pressure in the pre-chamber portion reaches a peak pressure value. The control valve then blocks fluid communication between the main combustion chamber and the pre-chamber portion.

### TECHNICAL FIELD

The present disclosure relates to a pre-combustion chamber assembly in an internal combustion engines. More particularly, the present disclosure relates to a control valve to limit peak pressure in the pre-combustion chamber assembly.

### BACKGROUND

Internal combustion engines (ICE) are commonly known to employ a number of combustion cylinders, where an air-fuel mixture is burnt to produce power required to run a machine. In some internal combustion engine applications, such as gaseous fuel applications, a combustion system includes a pre-combustion chamber in addition to a main combustion cylinder. Typically, the pre-combustion chamber is located in a cylinder head and is in fluid communication with the main combustion chamber of the engine via a number of small orifices. During operation the pre-combustion chamber is adapted to receive the air-fuel mixture which is ignited by a spark plug located within the pre-combustion chamber. Ignition of the air-fuel mixture in the pre-combustion chamber creates a flame of burning fuel which is jetted or otherwise advanced through the orifices into the main combustion chamber, thereby igniting an air-fuel mixture therein.

As is customarily known, NOx gases are produced during ignition of the air-fuel mixture in the pre-combustion chamber and the main combustion chamber. The NOx of the pre-combustion chamber propagate with the resulting flame to the main combustion chamber and causes a poor combustion of the air-fuel mixture in the main combustion chamber. This results in relatively lower fuel economy. Further, addition of NOx formation in the pre-combustion chamber increases a total NOx formation in the engines. In conventional engines, the NOx gases produced in the pre-combustion chamber and the main-combustion chamber are reduced in an after-treatment system.

U.S. Pat. No. 5,454,356 discloses a combustion engine with a pre-chamber and main chamber connected by a connection passage opened and shut by a control valve. The operation of this control valve uniformly mixes the air of the pre-chamber and the main chamber. However, the '356 reference does not disclose a solution for controlling pressure spikes in the pre-chamber which results in higher NOx in pre-chambers.

The present disclosure is directed towards one or more above-mentioned problems.

### SUMMARY OF THE INVENTION

Various aspects of the present disclosure describe an engine with a cylinder and a cylinder head. The engine includes a main combustion chamber and a pre-combustion chamber assembly. The main combustion chamber is disposed in the cylinder. The pre-combustion chamber assembly is disposed in the cylinder head proximal to the main combustion chamber. The pre-combustion chamber assembly includes a pre-chamber portion, a tip portion, and a control valve. The pre-chamber portion is in a fluid communication with the main combustion chamber. The tip portion is proximal to the main combustion chamber. The tip portion includes at least one orifice to allow the fluid communication between the main combustion chamber and the pre-chamber portion. The control valve includes an outer valve body. The control valve is accommodated in the pre-chamber portion and is mechanically switchable between a closed position and an open position. The control valve is adapted to be switched to the closed position when fluid pressure in the pre-chamber portion reaches a peak pressure value. The control valve then blocks fluid communication between the main combustion chamber and the pre-chamber portion.

### BRIEF DESCRIPTION OF THE DRAWINGS

FIG. 1 is a sectional view of an engine showing a pre-combustion chamber assembly, showing a control valve in an open position, in accordance with the concepts of the present disclosure; and

FIG. 2 is a sectional view of the pre-combustion chamber assembly showing the control valve of FIG. 1 in a closed position, in accordance with the concepts of the present disclosure.

### DETAILED DESCRIPTION

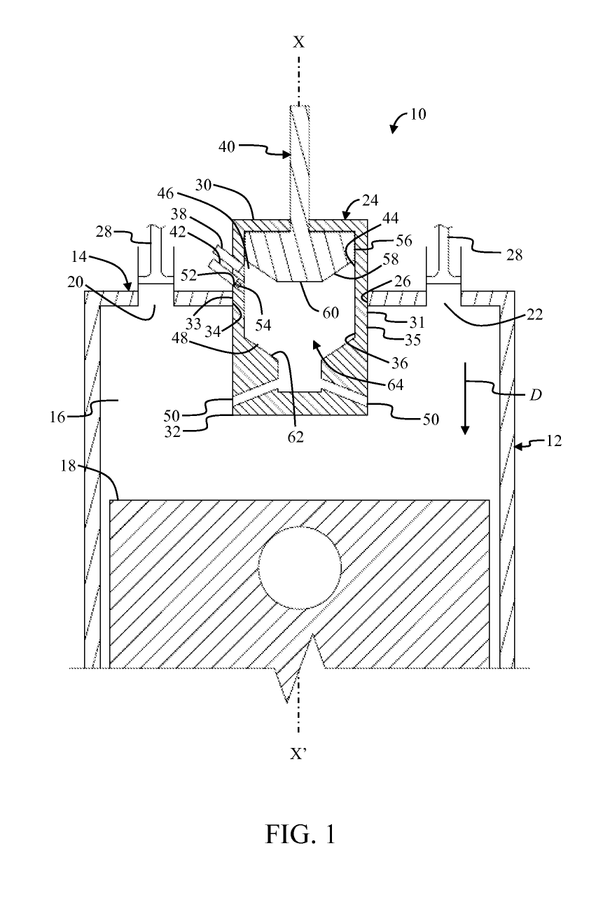

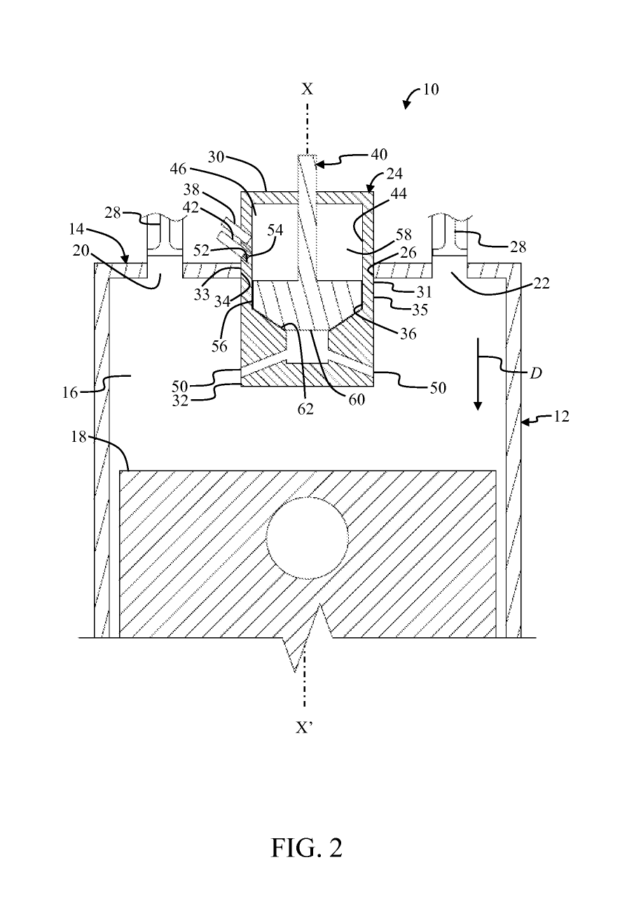

Referring to FIGS. 1 and 2, there is shown a partial sectional view of an engine 10. The engine 10 includes a cylinder 12 and a cylinder head 14. The cylinder 12 includes a main combustion chamber 16 and a piston 18. The piston 18 is slidably disposed within the cylinder 12 to reciprocate between a top-dead-center position and a bottom-dead-center position. The main combustion chamber 16 accommodates an air-fuel mixture, which is ignited to produce power.

The cylinder head 14 is engaged with an engine block (not shown) to cover the cylinder 12 and define the main combustion chamber 16 of the cylinder 12. The cylinder head 14 includes an intake opening 20, an exhaust opening 22, a pre-combustion chamber assembly 24, and a pre-chamber assembly bore 26. The intake opening 20 allows intake gases into the main combustion chamber 16. The exhaust opening 22 allows exhaust gases out of the main combustion chamber 16. Engine valves 28 are positioned to selectively open and close the intake opening 20 and the exhaust opening 22.

The pre-chamber assembly bore 26 is disposed in the cylinder head 14 between the engine valves 28. The pre-chamber assembly bore 26 opens into the main combustion chamber 16. The pre-chamber assembly bore 26 is structured to accommodate the pre-combustion chamber assembly 24.

The pre-combustion chamber assembly 24 is disposed in the pre-chamber assembly bore 26 in the cylinder head 14. The pre-combustion chamber assembly 24 extends from the cylinder head 14 into the main combustion chamber 16. The pre-combustion chamber assembly 24 may be configured in a variety of ways. An assembly capable of being positioned in the cylinder head 14 to support a combustion event outside of the main combustion chamber 16, and direct the combustion into the main combustion chamber 16 may be used.

The pre-combustion chamber assembly 24 includes a top portion 30, a neck portion 31, and a tip portion 32. The top portion 30 may be secured to the cylinder head 14 via fasteners (not shown).

The neck portion 31 includes a first sealing surface 33. The first sealing surface 33 is disposed about the neck portion 31 at a predetermined location. The first sealing surface 33 is provided to seal against a second sealing surface 34 provided in the cylinder head 14. The second sealing surface 34 is located in the pre-chamber assembly bore 26.

In addition, the neck portion 31 includes a wall 35, a bore 36, a fuel admission valve 38, a control valve 40, and a spark plug 42. The wall 35 defines the bore 36. The bore 36 is structured along a longitudinal axis, X-X′ of the pre-combustion chamber assembly 24. The bore 36 is surrounded by an inner periphery 44. The bore 36 includes an upper portion 46 and a pre-chamber portion 48. The bore 36 is in fluid communication with the main combustion chamber 16, via orifices 50 of the tip portion 32.

The pre-chamber portion 48 includes a threaded bore 52 that extends through the wall 35. The threaded bore 52 is adapted to receive the spark plug 42. The spark plug 42 is positioned in the neck portion 31 such that a spark plug tip 54 extends in the pre-chamber portion 48. The spark plug 42 in the context of this disclosure means a suitable ignition device available in the art.

The fuel admission valve 38 is adapted for delivery of fuel to the pre-chamber portion 48, which is disposed in the neck portion 31. The fuel admission valve 38 is in fluid communication with the pre-chamber portion 48. The fuel admission valve 38 delivers fuel, such as gaseous fuel, into the pre-chamber portion 48.

The bore 36 houses the control valve 40. The control valve 40 is mechanically actuated via a cam (not shown) or a rocker arm arrangement or similar mechanism known in the art. The control valve 40 includes an outer valve body 56 and a valve tip 58. The control valve 40 is housed in the bore 36 such that the outer valve body 56 is in contact with the inner periphery 44. The valve tip 58 faces the pre-chamber portion 48. Valve tip end 60 of the valve tip 58 is shaped and structured to complement an end portion 62 of the pre-chamber portion 48. The control valve 40 is mechanically switchable between a closed position and an open position. Actuation of the control valve 40 may be mechanically controlled by a controller (not shown), which may be in control communication with one or more pressure sensors (not shown) installed inside the pre-chamber portion 48.

Referring to FIG. 1, there is shown the open position of the control valve 40. In the open position, the control valve 40 is accommodated in the upper portion 46 of the bore 36 and defines a pre-chamber volume 64 between the valve tip 58 and the tip portion 32. With reference to FIG. 2, the closed position of the control valve 40 is shown. When fluid pressure in the pre-chamber portion 48 reaches a peak pressure value, the control valve 40 is actuated to the closed position. To attain the closed position, the control valve 40 moves downwards in a longitudinal direction, D. In the closed position, the control valve 40 moves away from the upper portion 46 and is accommodated in the pre-chamber volume 64 of the pre-chamber portion 48. This blocks fluid communication between the pre-chamber portion 48 and the main combustion chamber 16.

The tip portion 32 is generally cylindrical and is located below the neck portion 31. The tip portion 32 is positioned near the main combustion chamber 16. The tip portion 32 is received in the pre-chamber assembly bore 26. The pre-chamber assembly bore 26 allows the tip portion 32 to extend into and be exposed to the main combustion chamber 16.

The tip portion 32 includes a number of spaced apart, radially oriented orifices 50. The orifices 50 open into the pre-chamber portion 48 and into the main combustion chamber 16. The orifices 50 direct the expanding gases from the pre-chamber portion 48 in a predetermined pattern into the main combustion chamber 16.

### INDUSTRIAL APPLICABILITY

With reference to the drawings, and in operation, the pre-combustion chamber assembly 24 may be installed in the cylinder head 14. A fuel system (not shown) may supply a mixture of gaseous fuel and air to the pre-chamber portion 48 via the fuel admission valve 38. The spark plug 42 mounted to the pre-combustion chamber assembly 24 ignites the mixture of gaseous fuel and air within the pre-chamber portion 48. After combustion of the mixture of gaseous fuel and air within the pre-chamber portion 48, the burning fuel, for example, in the shape of torches may be emitted into the main combustion chamber 16 via the orifices 50. There, the burning fuel may initiate the main combustion process and may ignite a mixture of gaseous fuel and air within the main combustion chamber 16 supplied by the intake opening 20.

During pre-chamber combustion, the control valve 40 is in the open position. The control valve 40 is maintained in the open position, as fluid pressure in the pre-chamber portion 48 is below the peak pressure value. Towards the end of a compression stroke, the torches propagating through the orifices 50 initiate the main combustion process. During the main combustion process, temperature in the main combustion chamber 16 rises. Owing to the fluid communication between the pre-chamber portion 48 and the main combustion chamber 16, the temperature is communicated to the pre-chamber portion 48 as well. As the fluid pressure in the pre-chamber portion 48 reaches the peak pressure value, the control valve 40 is actuated to move downwards towards the tip portion 32. Thus, the closed position of the control valve 40 is attained. This implies that the Valve tip end 60 of the control valve 40 lies in registration with the end portion 62 of the inner periphery 44 of the pre-chamber portion 48. Therefore, the fluid communication between the pre-chamber portion 48 and the main combustion chamber 16 is blocked and hence, there is no rise in temperature in the pre-chamber portion 48 beyond the peak pressure value. This results in reduction of NOx formation, by limiting the time of exposure of the pre-chamber portion 48 to high temperatures of the main combustion chamber 16.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

1. An engine having a cylinder with a cylinder head, the engine comprising:
a main combustion chamber disposed in the cylinder;
a pre-combustion chamber assembly disposed in the cylinder head proximal to the main combustion chamber, the pre-combustion chamber assembly including a pre-chamber portion being in a fluid communication with the main combustion chamber, the pre-combustion chamber assembly including:
a tip portion proximal to the main combustion chamber, the tip portion having at least one orifice to allow the fluid communication between the main combustion chamber and the pre-chamber portion; and
a control valve with an outer valve body, the control valve being accommodated in the pre-chamber portion and being mechanically switchable between a closed position and an open position,
wherein the control valve is adapted to be switched to the closed position when fluid pressure in the pre-chamber portion reaches a peak pressure value and block the fluid communication between the main combustion chamber and the pre-chamber portion.
